(19) United States
(12) Patent Application Publication
(10) Pub. No.: US 2021/0295419 A1
(43) Pub. Date: Sep. 23, 2021

(54) SYSTEMS AND METHODS FOR MODIFYING WEB PAGES WITH ANCILLARY CONTENT AND CREATING, DISTRIBUTING, AND TRACKING KARMACREDITS

(71) Applicant: ImpactKarma Inc., Raleigh, NC (US)

(72) Inventors: Kedar Karkare, Houston, TX (US); Jayant Khadilkar, Raleigh, NC (US)

(21) Appl. No.: 17/159,940

(22) Filed: Jan. 27, 2021

Related U.S. Application Data
(60) Provisional application No. 62/966,349, filed on Jan. 27, 2020.
(60) Provisional application No. 63/018,009, filed on Apr. 30, 2020.

(51) Int. Cl. G06Q 30/06; G06K 7/14; G06K 7/10

(52) U.S. Cl. CPC G06Q 30/0641; G06K 7/10297; G06K 7/1417

(57) ABSTRACT

One example method for modifying web pages with ancillary content includes detecting an identifier for a requested shopping web page, the identifier comprising product information; requesting impact score information based on the product information; receiving the requested shopping web page; receiving the impact score information; modifying the shopping web page to add the impact score information; and displaying the modified shopping web page.

### CROSS-REFERENCE TO RELATED APPLICATIONS

This application claims priority to U.S. Provisional Patent Application No. 62/966,349, filed Jan. 27, 2020, titled “Systems and Methods for Modifying Web Pages with Ancillary Content” and to U.S. Provisional Patent Application No. 63/018,009, filed Apr. 30, 2020, titled “Systems and Methods for Modifying Web Pages with Ancillary Content and Creating, Distributing, and Tracking KarmaCredits,” the entireties of both of which are incorporated herein by reference.

### BACKGROUND

Consumers commonly research and purchase items in online marketplaces. To do so, they may access an online marketplace and search for one or more items of interest. Upon finding such an item, they may navigate to a description of the item that includes the option to purchase it. The user can then decide whether to purchase the item or find an alternate product.

### SUMMARY

Various examples are described for systems and methods for modifying web pages with ancillary content and creating, distributing, and tracking KarmaCredits. One example method includes detecting an identifier for a requested shopping web page, the identifier comprising product information; requesting impact score information based on the product information; receiving the requested shopping web page; receiving the impact score information; modifying the shopping web page to add the impact score information; and displaying the modified shopping web page.

One example system includes a non-transitory computer-readable medium; a communications interface; and a processor communicatively coupled to the non-transitory computer-readable medium and the communications interface, the processor configured to execute processor-executable instructions configured to cause the processor to detect an identifier for a requested shopping web page, the identifier comprising product information; request impact score information based on the product information; receive the requested shopping web page; receive the impact score information; modify the shopping web page to add the impact score information; and display the modified shopping web page.

One example non-transitory computer-readable medium includes processor-executable instructions configured to cause a processor to detect an identifier for a requested shopping web page, the identifier comprising product information; request impact score information based on the product information; receive the requested shopping web page; receive the impact score information; modify the shopping web page to add the impact score information; and display the modified shopping web page.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system for modifying web pages with ancillary content;

FIG. 2 shows an example method for modifying web pages with ancillary content;

FIG. 3A shows an example web page before modifications;

FIG. 3B shows an example modified web page having ancillary content;

FIGS. 4A-4B show an example device for modifying web pages with ancillary content;

FIG. 5 shows an example method for modifying web pages with ancillary content;

FIG. 6 shows an example system for creating, distributing, and tracking KarmaCredits;

FIGS. 7 and 8 show example blockchains suitable for use by examples systems according to this disclosure; and

FIG. 9 shows an example computing device suitable for modifying web pages with ancillary content.

### DETAILED DESCRIPTION

Examples are described herein in the context of systems and methods for modifying web pages with ancillary content. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

When shopping online, users may be unaware of the social, environmental, or other impact their purchases may have. While individuals may research the companies whose products they purchase, that can be difficult and time consuming. But if presented with such information while contemplating purchasing a product, the consumer may be able to adjust their purchasing decisions and select products from companies that better align with the consumer's preferences.

For example, if a user is browsing a shopping website, she may search for a particular product and receive back search results for a variety of different products fitting her search parameters. At which time, she may select one of the products to view the corresponding web page for the product at the shopping website, referred to as a “product page” or a “product web page.” At such time, the user's web browser issues a request to a content server at the shopping website for the selected product page.

When she browses to the product page of interest using her web browser, a browser extension detects that a product page has been requested, such as by analyzing the uniform resource locator (“URL”) for the requested product page and detecting a known shopping website, e.g., www.onlinemarketplace.com. The browser extension may then examine the URL to detect production information, e.g., a product name or a brand, or a unique identifier for the product (e.g., as a serial number or a stockkeeping unit (“SKU”) associated with the shopping website). If such information is detected, the browser extension then transmits a request to a cloud server for scoring information for the product.

The scoring information reflects a societal and environmental impact score (or “impact score”) for the product or the associated brand, or the company that owns the brand and sells the product. The impact score reflects information about the product/brand/company's environmental impact (e.g., carbon emissions, renewable energy usage, etc.), labor impact (e.g., labor wage practices, use of child labor, etc.), societal impact (e.g., community involvement, charitable contributions, etc.), and other factors.

Impact scores may be based on suitable information about factors such as those described above obtained from any suitable source. For example, the United Nations identifies seventeen different sustainable development goals, including poverty, hunger, health and well-being, etc. One way to develop an impact score is to rate a company regarding whether or not it addresses each of these seventeen goals with either a ‘0,’ if the company does not have a stated policy or business practice to address a particular goal, or a ‘1,’ if it does. The company's impact score may then be calculated by summing the goals with a score of ‘1.’ Further, from this impact score, one or more sub-scores may be computed, such as sub-scores targeting particular goals, such as goals that target the individuals in the human population directly (e.g., poverty and hunger) and those that more target more general goals (e.g., sustainable cities or climate action). Such sub-scores may be calculated in the same manner, such as by summing the scores corresponding to the sub-score category.

It should be appreciated that using a binary “0” or “1” score may be supplanted by using numerical ranges, e.g., 0-10, to allow for finer grading. Further, the scores may then be weighted according to areas of particular emphasis. For example, if the impact score is to be weighted towards issues of poverty, inequality, and hunger, weights may be applied to the score for a particular goal, e.g., a weight of 1.5 or 2 may be applied to the score for a particular goal. The scores may then be summed as discussed above.

In some examples the sum total of the various scores may be further adjusted, e.g., to normalize the score to a range. For example, to normalize a score to a range from 0-100, the scores may be summed and divided by the total number of possible points (and adjusted by any corresponding per-goal weights). This value may then be multiplied by 100 to obtain a ranking score between 0 and 100. Such a technique may allow different companies to be compared to each other on a common scale. Further, this same methodology could be applied to sub-scores to allow impact scores for specific sub-scores to be determined.

These impact scores and sub-scores may then be stored in a suitable database to be accessed using systems and methods according to this disclosure. The impact score may then be displayed as a single number computed from such underlying information, or it may be stored and presented as multiple impact scores, e.g., one impact score for each of a number of categories.

When the web browser receives the requested product page from the shopping website's content server, it begins rendering the web page. However, the browser extension also receives scoring information from the cloud server, indicating that impact score information was located for the identified product and indicating the impact score for the product. The browser plugin then inserts code into the received web page to add the impact score onto the product page. Thus, when the user views the modified product page, she can see all of the relevant information about the product provided by the shopping website, but she can also see the impact score that has been inserted onto the product page. Based on the impact score, the user can then make a more informed decision about the products and sellers before she makes a purchase.

In addition to inserting the impact score, the browser extension can also request information about competing products to the one requested by the user from the cloud server, as well as their respective impact scores. After receiving product information for the additional products and their corresponding impact scores, the browser extension further modifies the product page to insert links and information about the competing products and their respective impact scores. Thus, the user can be presented with the impact score for not only the product she specifically selected, but impacts impact scores for competing products, thereby enabling the user to select a product to purchase.

By modifying a product page to insert impact score information and additional product links, this illustrative example is able to present a more complete picture to the user about the product she has selected and its environment, societal, etc. impact as well as see other options that may have similar or better impacts per the user's preferences.

This illustrative example is given to introduce the reader to the general subject matter discussed herein and the disclosure is not limited to this example. The following sections describe various additional non-limiting examples and examples of systems and methods for modifying web pages with ancillary content.

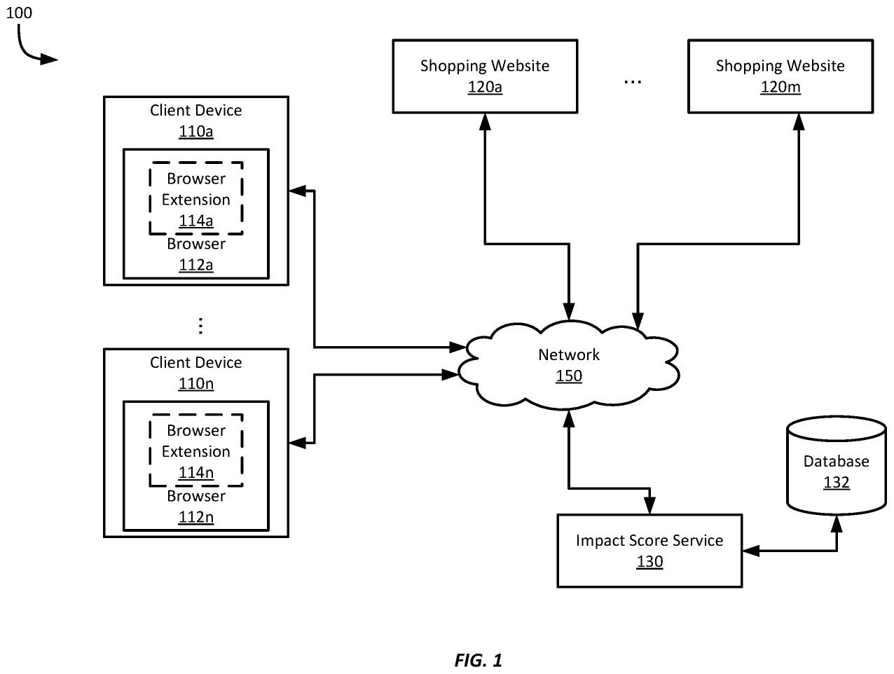

Referring now to FIG. 1, FIG. 1 shows an example system 100 for modifying web pages with ancillary content. In this example, the system 100 includes multiple client devices 110a-n, multiple shopping websites 120a-m, and an impact score service 130. The client devices 110a-n, content providers 120a-m, and impact score service 130 are all in communication over one or more communication networks 150. In this example, the network 150 is the internet, however, any suitable network may be employed, including a local area network (“LAN”); a wide area network (“WAN”), such as the internet; metropolitan area network (“MAN”); etc. It should be appreciated that the ‘n’ in client device 110n's label is intended to indicate an arbitrary number of client devices, e.g., n client devices. Similarly, the ‘m’ in content provider 120m's label also indicates an arbitrary number of clients, e.g., m content providers. It should be appreciated that either or both of m and n may have any value of one or greater.

Each client 110a-n executes a web browser 112a-n that allows a user to access content available via the network 150, such as one or more web sites 120a-m. Any suitable web browser may be employed, such as Chrome®, Internet Explorer®, Safari®, Firefox®, etc. In this example, each web browser 112a-n includes a web extension 114a-n to detect requested URLs and obtain impact score information corresponding to products sold on the shopping websites 120a-m, such as the impact score for the company that produced the product.

To access content using a web browser, such as web browser 112a, the user may enter a uniform resource identifier (“URI”), such as a URL, for a web page into a navigation bar or may select a hyperlink. The web browser 112a then issues a request to the server associated with the selected URI, such as a server associated with one of the shopping websites 120a-m. The server may then respond to the request and provide the web page. The web page may include one or more references to other objects, such as images, videos, graphics, advertisements, or other content, which are also retrieved by the web browser 112a and displayed as defined within the web page.

The shopping websites 120a-m each represent one or more servers that host web pages or web objects available for retrieval by a web browser 112a-n. For example, a shopping website may be one or more servers that maintain product pages for products sold through the respective shopping website.

Impact score service 130 includes one or more servers that provide impact scores according to this disclosure. In this example, impact score service 130 receives requests from a web browser 112a corresponding to products, brands, companies, etc., accesses impact score information associated with the provided information, and provides impact score information to the requesting web browser. The provided information may include an aggregated impact score, multiple individual impact scores for specific categories, graphical information (e.g., representations of such impact scores), descriptive text corresponding to the impact scores, ranking information, etc.

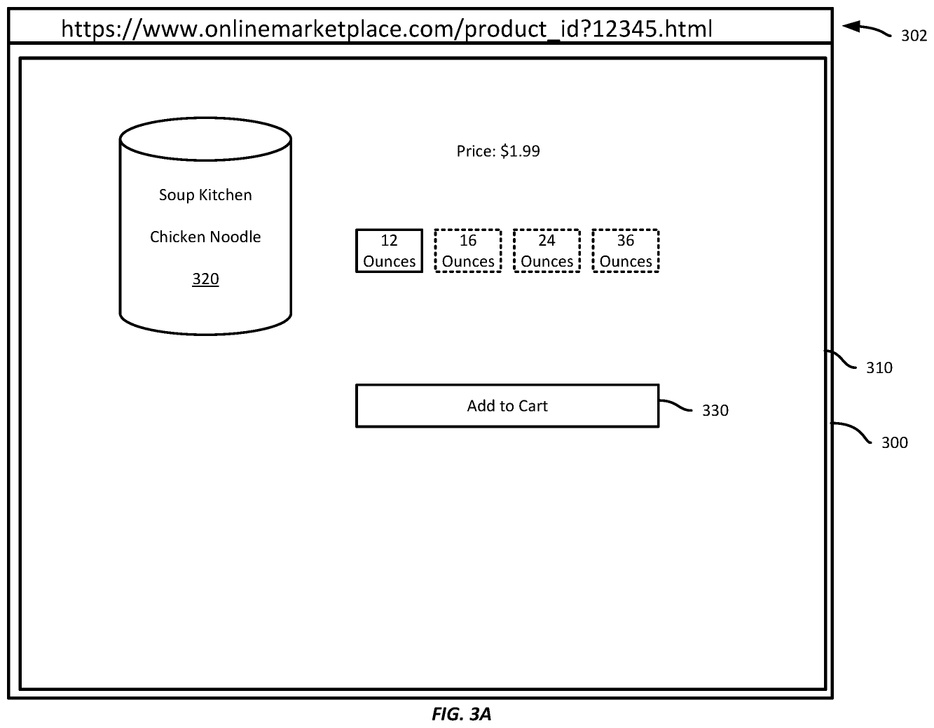

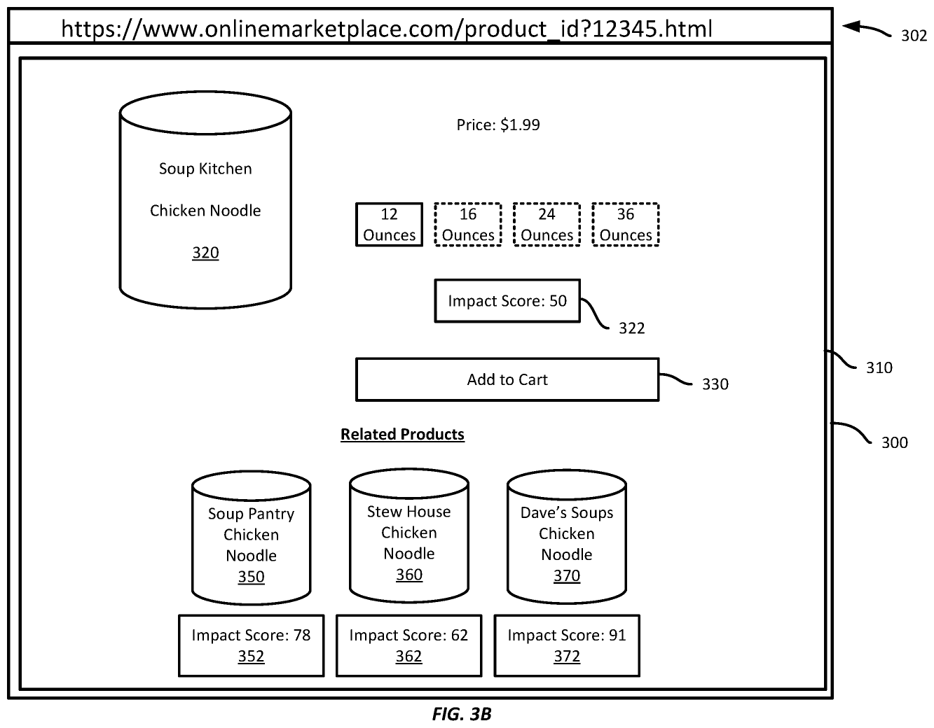

Using this example system 100, a user may use a web browser 112a to access a shopping website 120a via its web site. While browsing the web site, the user may identify a product of interest and access a product page. For example, the user may select a product page for Soup Kitchen's Chicken Noodle soup, shown in FIG. 3A. As can be seen in FIG. 3A, the product page 310 displayed in a web browser window 300 provided by the shopping website 112a includes an image of the product 320, a price, size options, etc and an “Add to Cart” button 330.

After selecting a URL 302 for the product page in FIG. 3A, such as by clicking a hyperlink or an image of the product, the browser extension 114a detects the requested product page, such as by intercepting the initial request for the product page, including the requested URL 302, or by intercepting the returned web page document, e.g., a hypertext markup language (“HTML”) web page. The browser extension 114a then scans the URL 302 to identify product information, such as a product name, a brand name, a company name, a unique identifier (e.g., a SKU), etc. that identifies the product or associated information the user has selected.

If the product information in the URL includes a product name, brand name, or a company name, the browser extension 114a sends a message to the impact score service 130 requesting impact score information for product/brand/company. In this case, the product information includes a unique identifier, “12345” in this example, and the browser extension 114a communicates with the shopping website 120a to obtain information about the product using the unique identifier, e.g., by interacting with an API made available by the shopping website. After receiving the product information from the shopping website via such a request, the web extension may then issue the request to the impact score service 130 using the obtained product information.

The impact score service 130 receives the request from the browser extension 114a and accesses product/brand/company and impact score information stored in the data base 132. To obtain the impact score information in this example, the impact score service 130 identifies the company that supplies the product or that owns the brand and obtains impact score information for the company. However, in some examples, the impact score information may be available at a more granular level, including at the level of individual brands or products, e.g., based on materials used in the product. The impact score information is then sent by the impact score service 130 to the browser extension 114a.

The impact score information may include any suitable information to provide information to a consumer about the brand's, product's, or company's impact on the environment, a community, its workforce, etc. For example impact score information may include a rating, e.g., on a scale of 1 to 100, of the company's carbon emissions, use of sustainable materials, ethical trade practices, fair wages, family leave policies, etc. Alternatively, the impact score information may include only a single rating for the company, where the rating corresponds to an overall social responsibility impact score associated with the company. In some examples, the impact score information may include text descriptions or summaries of the company's environmental, labor, charity, community, etc. standards. Such impact score information may be represented using text, graphics (e.g., bar charts, colors, etc.), or other visual, audible, or tactile techniques.

The browser extension 114a modifies the requested product page to include the impact score information from the impact score service 130. In this example and as shown in FIG. 3B, the browser extension 114a modifies the product page 310 when it is received from the shopping website 120a to insert a script to display impact score information 322 once available from the impact score service or an indicator that no impact score information is available (or that it will soon be available). In some examples, however, the browser extension 114a may modify the product page after receiving the impact score information. Further, some examples may not insert a script into the web page, but instead may include text and graphics directly into the web page, e.g., based on a location of a product image, product description or information on the product page, an “add to cart” button 330 on the product page, etc.

In some examples the modified web page may enable the user to interact with the impact score information, such as by selecting a graphical indicator of the impact score, e.g., a red/yellow/green stoplight, added to the product page by the browser extension 114a. By interacting with the indicator, the user may be able to access more detailed information about the impact score, such as impact scores for individual categories, textual descriptions of the various categories or the company's policies, comparisons with competing brands, etc.

In some examples, the browser extension 114a may also send a request to the impact score server 130 for information about competing products and their associated impact score information. The impact score service 130 may obtain such information from the database 132 and provide it to the browser extension 114a. The browser extension 114a may then further modify the product page to add links 350-370 to the competing products on the shopping websites 120a as well as impact score information 352-372 for one or more of the competing products. Such a modification of the product page may enable the user to compare the selected product with competing products as well as compare their respective impact scores. Based on such information the user may navigate to a different product page to view a product that may be more desirable based on the provided impact score information.

In some examples, the browser extension 114a may also track the user's purchases to track impact scores for products the user purchases. Such information may be used to update a user profile, e.g., a user profile the user has created with the impact score service 130. By purchasing products with higher impact scores, e.g., above a threshold, the user may be identified as a socially, environmentally, etc. conscious consumer and may be identified to companies that have high impact scores as a consumer who may be interested in their products. For example, the impact score service 130 may determine an average or normalized impact score for products purchased by the user. Such information may also be provided to the user to help motivate them to purchase goods and services from socially conscious companies, e.g., by rating the consumer based on the products they buy. Further, based on the amount of money spent by the consumer to purchase high impact score products, the consumer may be targeted by brands as one who may be a valuable customer. For example, the more money a consumer spends on high impact score products, she may be associated with different tiers of impactful consumers and targeted to receive higher-value promotions or discounts.

Further, as the user accumulates purchases of high-impact score items, she may receive incentives, such as discounts or special promotions offered by companies with high impact scores that match the kinds of products the consumer purchases, or she may be awarded points or incentive points called “KarmaCredits” that may be redeemed for discounts, free products, charitable contributions by the company on behalf of the consumer, etc., or the consumer may trade KarmaCredits with other consumers or any other entity for money or other asset of value, such as via an exchange. In some examples, the consumer may transfer KarmaCredits to the impact score service 130 in a form of a “buyback” of the KarmaCredits by the impact score service 130. In some examples, the consumer may be awarded KarmaCredits for referring a friend to the program or if a referral reaches a threshold level of KarmaCredits. Such information may be provided to relevant companies for its own marketing purposes, or invitations to such sales and promotions may be mediated by the impact score service 130 itself. For example, a company may wish to begin a promotional campaign and may notify the impact score service 130 of the campaign. The impact score service 130 may then notify registered consumers having a certain minimum ranking of the promotional campaign, and in return may receive compensation for purchases made by such consumers.

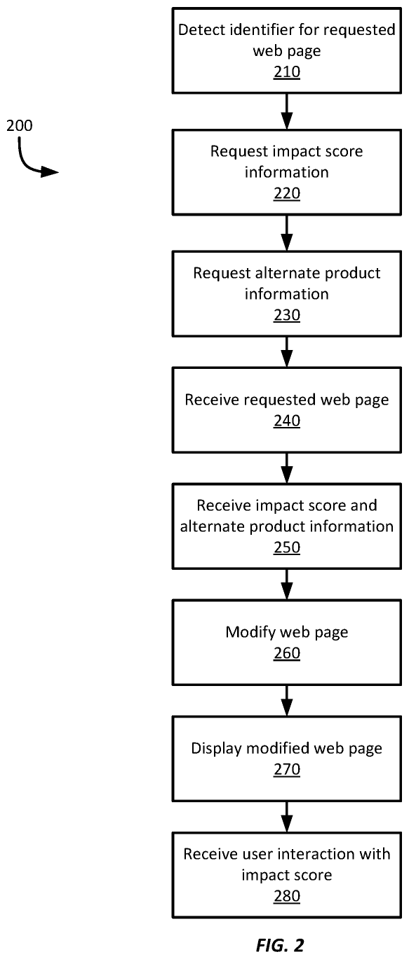

Referring now to FIG. 2, FIG. 2 shows an example method 200 for modifying web pages with ancillary content. This method will be described with respect to the example system shown in FIG. 1, however, any suitable system according to this disclosure may be employed.

At block 210, the browser extension 114a detects an identifier for a requested web page, the identifier comprising product information. In this example, the browser extension 114a detects a URL for a requested product page. Using the identifier, the browser extension 114a is able to determine information about the product, such as the product name, brand, selling company, etc. In some examples, as discussed above, the browser extension 114a may request additional information from a shopping website 120a-m.

At block 220, the browser extension 114a requests impact score information based on the product information. For example, the browser extension 114a may send a request for impact score information for a product, brand, or company name to the impact score service 130.

At block 230, the browser extension 114a requests alternate product information from the impact score service 130. For example, the browser extension 114a may request the alternate product information within the same request for the impact score information or via a separate request.

At block 240, the web browser 112a (or browser extension 114a) receives the web page, such as from a shopping website 120a-m.

At block 250, the browser extension 114a receives impact score information and alternate product information (if requested) from the impact score service 130. It should be appreciated that the impact score information and the alternate product information may be obtained from multiple different sources.

At block 260, the browser extension modifies the web page to insert the impact score information and alternate product information, generally as discussed above with respect to FIG. 1.

At block 270, the web browser 112a displays the modified web page to allow the user to view the selected product and the corresponding impact score and alternate product information.

At block 280, the user may click on the impact score, such as by clicking a button to view the impact score in an overlay window displayed over the web page or by mousing over an impact score icon to view such an overlay window.

Once the user has clicked on the impact score, they may obtain more detailed information, such as components of the impact score. For example, as described above, an impact score may be generated from multiple individual ratings, e.g., the UN goals discussed above. Thus, the user may be able to obtain scores corresponding to different sustainable development goals. Thus, they may be able to drill down into a score, which may enable them to determine whether the various component scores align with their particular preferences.

And while the example of FIGS. 2 and 3A-3B have been described with respect to a user engaging in online shopping via an online marketplace, examples according to this disclosure may be employed in a brick-and-mortar setting as well.

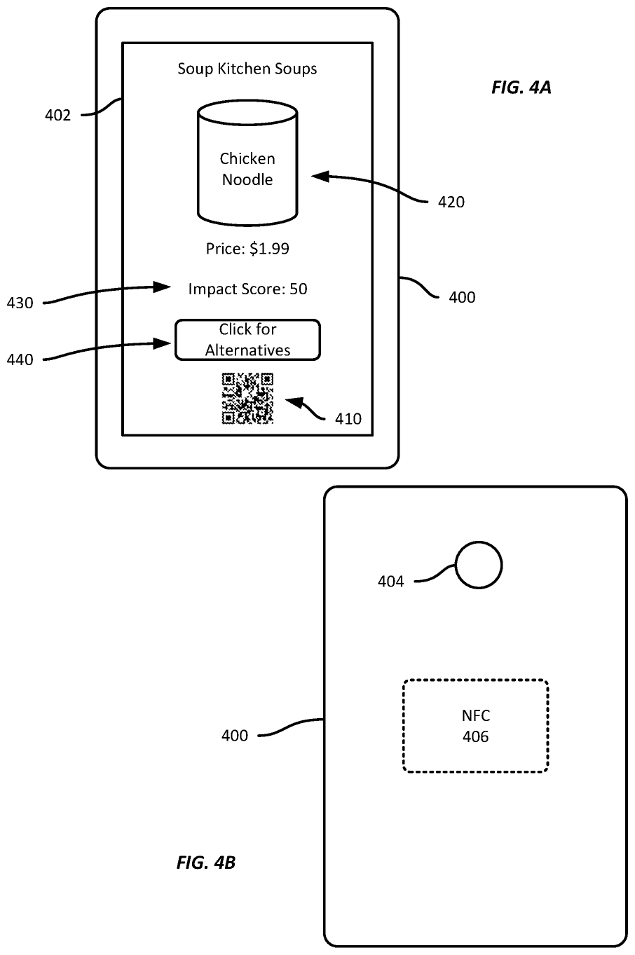

Referring to FIGS. 4A-4B, FIGS. 4A-4B show an example device 400 for modifying webpages with ancillary content. FIG. 4A shows the front face of the device 400, which includes a touchscreen display 402 that a user can interact with. FIG. 4B shows the rear face of the device, which includes an image sensor 404 and a near-field communications (“NFC”) device 406 that can be used as a scanning device to capture product codes. In this example, the device 400 is a smartphone, but it may be any suitable handheld or wearable device, such as a barcode or quick response (“QR”) code reader or a smartwatch, smart glasses, etc. Further, while the scanning device in this example is an image sensor 404, in some examples, the scanning device may be a laser scanner and receiver, a Bluetooth device, an NFC device 406, etc.

While shopping in a brick-and-mortar store, the user may browse for items on various shelves within the store. Items have price tags or product tags located either on the item or on the shelf near the item. These price or product tags may include machine-readable product codes, such as bar codes or QR codes that can be scanned by one of the scanning devices on the smartphone 400. When considering an item for purchase, the user may wish to know whether the company that produced the product or the product's brand is a socially conscious brand that aligns with the user's own preferences. However, such information may only be provided on the product packaging, if at all, and the user may be skeptical of such information.

To quickly access the company's or brand's impact score, the user can use the smartphone 400 to quickly scan the product's product code. In FIG. 4A, the user has scanned a QR code 410, which is displayed on the display 402. In this example, the QR code 410 encodes a URL link to a product page for the product at the store's commercial website. Thus, the smartphone 400 launches a web browser, requests the product page, and displays it to the user. However, as discussed above, the smartphone 400 detects that the requested web page is a product page for a product and proceeds to send a separate request for impact score information to the impact score service 130.

After receiving the product page, the smartphone 400 modifies it to include impact score information 430 that is received from the impact score service 130. Thus, the smartphone 400 displays the product page, which includes the product 420 and the corresponding company or brand, “Soup Kitchen Soups” in this example, and displays the impact score 430 for the user to see.

In addition to receiving the impact score 430, the smartphone 400 also receives information about products from other companies or brands that have similar or better impact scores to the company or brand that produced the scanned product. In this example, because the form factor of the smartphone is smaller than other devices, the alternatives are not displayed on the product page as they are in the examples shown in FIGS. 3A-3B. However, instead, the smartphone 400 provides an option for a user to press a virtual button 440 to obtain similar products from other companies or brands with similar or better impact scores.

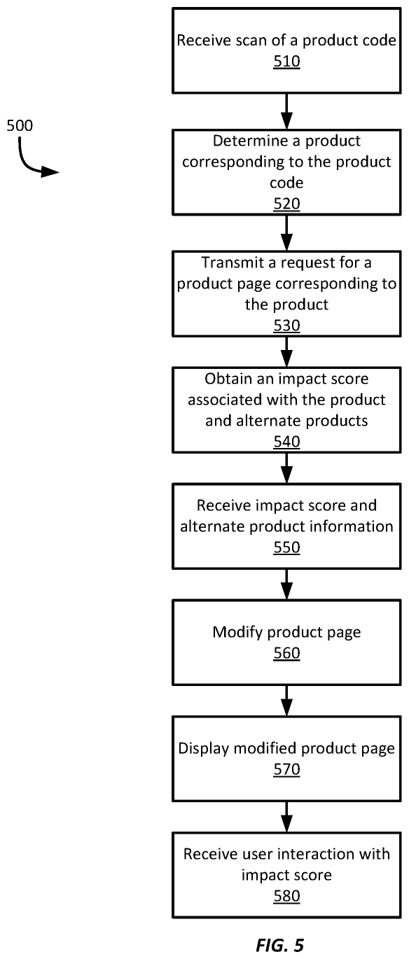

Referring now to FIG. 5, FIG. 5 shows an example method 500 for modifying web pages with ancillary content. The method 500 of FIG. 5 will be described with respect to the system 100 shown in FIG. 1 and the device 400 shown in FIGS. 4A-4B. However, it should be appreciated that methods according this disclosure may be performed with any suitable device or system.

At block 510, a user operates a device to scan a product code on a physical product. In this example, the user uses the camera 404 on their smartphone 404 to capture an image of a QR code on a physical product in a store. In other examples, however, any suitable scanning device may be employed, including NFC (e.g., to scan an RFID tag), Bluetooth (to scan a Bluetooth tag or beacon), a laser scanner, etc. Further, any suitable device may be employed. In some examples, portable or wearable devices, such as smartphones, smartwatches, smart glasses, dedicated handheld product code scanners, may be more convenient in some scenarios. But in other scenarios, any suitable computing device may be employed. For example, a user may employ a self-checkout system to complete a sale of an item. The self-checkout system may have an attached product code scanner that the user can use to scan items at checkout.

At block 520, device 400 determines a product corresponding to the product code. In some examples, the product code includes a URL for a product page for the item. QR codes can be used to encode URLs to enable users to quickly navigate to a particular web page, e.g., a product page at the source company's web site (the “source company” being the company that produced or supplied the product) or at an online marketplace where the product is also offered for sale. In some examples, however, the user may need to execute an application, e.g., an application provided by the store, to obtain product information corresponding to the product code, e.g., a SKU for the store. For example, if a user is shopping in a grocery store, they may execute an app on their smartphone provided by the grocery store. That app may enable the user to scan the product code and then lookup corresponding product information for that product.

At block 530, the smartphone 400 transmits a request for a product page corresponding to the product. In this example, after the user has scanned a QR code, which encodes a URL for the product page at the source company's web site. In other examples, such as described above, the smartphone 400 may execute an app provided by the source company or by the store in which the user is shopping. Such an app may then request the product page, e.g., via an integrated web browser or by launching a web browser on the user's smartphone 400.

At block 540, the smartphone 400 transmits a request for an impact score associated with the product as well as alternate products. In this example, the smartphone 400 determines the source company and the brand corresponding to the product and requests an impact score for one or both from an impact score service 130, generally as described above with respect to blocks 220 and 230. In an example where the app requests the product page via a web browser, a web browser extension may transmit the request to the impact score service 130 in a similar manner.

At block 550, the smartphone 400 receives the impact score and alternative products from the impact score service 130, generally as described above with respect to block 250.

At blocks 560 and 570, the smartphone 400 modifies and displays the product page generally as described above with respect to blocks 260 and 270.

At block 580, the smartphone 400 receives a user interaction with the impact score, generally as described above with respect to block 280. Further, the user may also interact with the button 440 to obtain alternative products. Should the user select the button 440, the user may be presented with a page showing names and impact scores of alternate products, which may help the user locate such products in the store.

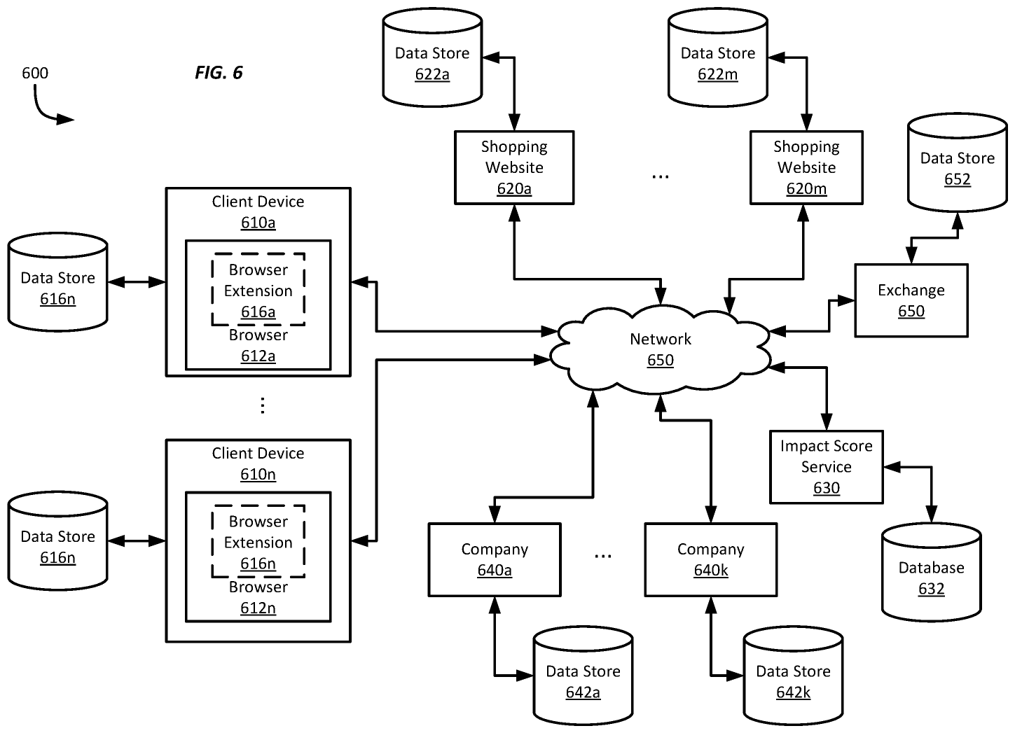

Referring now to FIG. 6, FIG. 6 illustrates an example system 600 for providing and managing KarmaCredits. As mentioned above, KarmaCredits may be provided to consumers or other entities as a form of currency or asset that may be exchanged for various purposes. To support the use of KarmaCredits, the example system shown in FIG. 6 enables the creation, distribution, and tracking of KarmaCredits.

The system 600 shown in FIG. 6 is similar to the system 100 shown in FIG. 1; however, system 600 also includes any number of companies 640a-k. While the system of FIG. 1 involved shopping websites 120a-m, which may be hosted by an individual company, the distinction between a shopping website and companies (or brands) is highlighted with respect to FIG. 6.

As a means to both help encourage consumers to purchase products from particular companies, and to encourage companies to improve their impact scores, KarmaCredits may be generated and awarded to consumers when they purchase a company's or brand's goods and services. These KarmaCredits may be stored as assets, donated, exchanged for other things of value, such as for money on an open exchange or in exchange for goods or services, or otherwise transferred to another person or entity. In the system 600 shown in FIG. 6, KarmaCredits are created by the impact score service 630 and distributed to other entities, such as companies 640a-k, which may then award them to consumers or other entities for purchasing products, during promotional events, etc. It should be appreciated that this discussion is equally applicable to individual brands, rather than companies as a whole. For example, a company may have multiple different brands, each of which provides different products and each having its own impact score. Thus, while the discussion below generally targets companies, it is equally applicable to individual brands as well.

In general, KarmaCredits may be created by the impact score service 630 based on any suitable event, such as a request from a company for a number of KarmaCredits or from a shopping website based on sales of products of participating companies or brands. Those KarmaCredits may then be allocated and distributed to one or more entities. For example if a company wishes to provide KarmaCredits to purchasers of its products, it may request a number of KarmaCredits from the impact score service 630. The impact score service 630 may then issue a number of KarmaCredits to the company. Later, when a consumer uses their client device 610a-n to access a shopping website 620a-m and purchase an item sold by a company 640a-k, the consumer may be notified of the company's (or brand's) impact score as discussed above with respect to FIGS. 1 and 2, and also that KarmaCredits may be awarded for a purchase of the company's (or brand's) products. After the consumer purchases an item, a number of KarmaCredits may be awarded to the consumer by transferring KarmaCredits from the company to the consumer. The KarmaCredits may then accumulate in the consumer's KarmaCredit wallet or similar storage mechanism.

When creating one or more KarmaCredits, the impact score service 630 may create KarmaCredits for a company 640a-k based on its impact score. For example, if a company 640a requests 10,000 KarmaCredits, the impact score service 630 may issue those KarmaCredits based on the company's impact score. For example, if a company has an impact score of 50, that may correspond to an KarmaCredit value of eight KarmaCredits per dollar. Thus, 10,000 KarmaCredits for the company 640a would represent $1,250 worth of sales for the company. When a consumer later purchases an item, such as for $100, from the company 640a, the transaction would then award a number of KarmaCredits for the transaction based on the value of the KarmaCredits. In this example, the $100 sale would correspond to 800 KarmaCredits. Assuming the company 600a awards points for the full value of the sale price, 800 KarmaCredits would be transferred to the consumer. Despite the specifics given in the example above, any suitable approach to distributing KarmaCredits based on a company's (or brand's) impact score may be employed. In general, the number of KarmaCredits awarded to a company or brand should increase as its score gets higher, though the specific exchange rage may be selected as appropriate for a particular implementation. Further exchange rate need not increase linearly, but may instead increase exponentially or logarithmically, or even in discrete steps corresponding to different tiers, in some examples.

To accomplish the transaction on a shopping website 620a-m, after the consumer completes the purchase of an item, the shopping website 620a-m notifies the company (or brand) associated with the purchased product about the purchase. The company then initiates a transfer of KarmaCredits from its reserve to the consumer, such as using the blockchain techniques discussed below, and confirms the transfer to the shopping website 620a-m. The consumer is then notified of the received KarmaCredits, such as through the shopping website 620a-m or a notification from their KarmaCredit wallet or account.

To help maintain scarcity of in the pool of available KarmaCredits, in some examples, a percentage of KarmaCredits may expire after some exchanges, or even after every exchange. For example, if a consumer has 1,000 KarmaCredits and elects to use 100 to receive a discount on the purchase price of a product from company 640a, the consumer may transfer 100 KarmaCredits to the company 640a; however, company 640a may only receive 90 KarmaCredits, with 10 credits expiring as a result of the transaction. If the company 640a later issues those 90 KarmaCredits to a second consumer, e.g., as a reward for purchasing another product, the second consumer may receive all 90 KarmaCredits, but the company 640a may need to transfer 100 KarmaCredits to offset the 10% expiration rate. In some examples, KarmaCredits may only expire when redeemed by a consumer for a product, though in other cases, they may expire in any transfer, such as on an open exchange.

In a KarmaCredit exchange, a digital exchange 650 may allow holders of KarmaCredits to offer them for sale to other consumers (or any other suitable entity). The consumer may accept bids for KarmaCredits and, in response to accepting a bid, may transfer KarmaCredits to the bidder in exchange for money or other assets of value. In some examples, KarmaCredits may not expire within the context of such an exchange 650, though in some examples some number may expire.

To ensure proper expiry of KarmaCredits, transactions that exchange KarmaCredits may be required to be submitted to the impact score service 130, which manages the exchange and recording the transaction for record keeping purposes, e.g., on a blockchain. Thus, while an exchange 650 may be operated by any suitable entity, transactions not recorded on the blockchain managed by the impact score service 130 may not be recognized and thus transfers of KarmaCredits may not occur properly. Similarly, when KarmaCredits are used to purchase items, receive a discount, or other incentive, such transfers may also be mediated by the impact score service 130, which may manage expiry of points, but may also track the total number of KarmaCredits in circulation and thereby control the issuance of new KarmaCredits. If the impact point service 130 elects to stop issuing KarmaCredits for a period of time, companies wishing to award KarmaCredits may need to either purchase KarmaCredits from another entity or provide incentives that encourage consumers to spend KarmaCredits with the respective companies.

Examples according to this disclosure may create, distribute, and track KarmaCredits using a distributed record-keeping system, such as blockchain. In this example, each client device 610a-n, shopping website 620a-m, and company 640a-k is explicitly shown with a distinct data store 616a-n, 622a-m, 642a-k, which may be implicit to the system shown in FIG. 1. The data stores 616a-n, 622a-m, 632, 642a-k in this example maintain records of KarmaCredits in circulation and their respective ownership, which are stored in a blockchain 500 distributed amongst the client devices 610a-n, shopping websites 620a-m, impact score service 630, and companies 640a-k, and stored within their respective data stores 616a-n, 622a-m, 632, 642a-k. This collection of computing devices and data stores is referred to as a “blockchain network” and has distributed within it one or more blockchains, also referred to as “ledgers.” Further, within the blockchain network, each of the individual computing devices is referred to as a “node.”

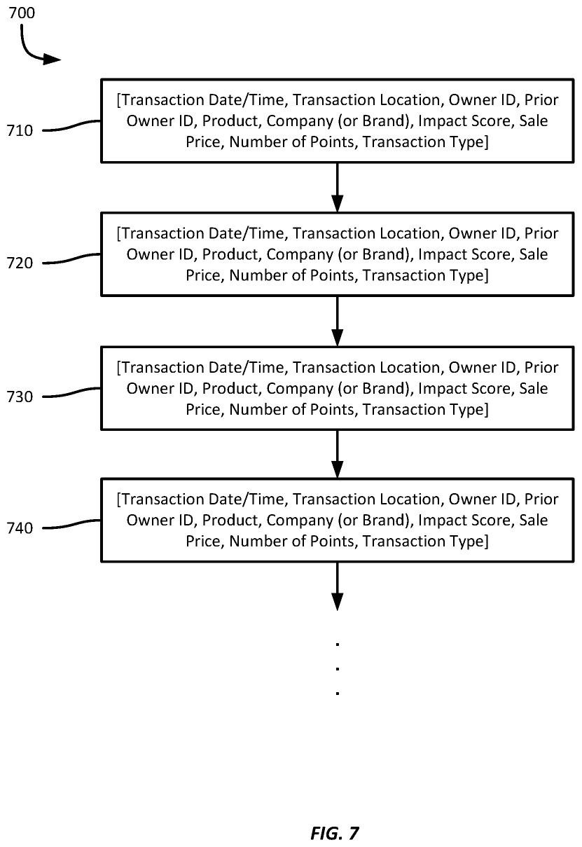

Referring now to FIG. 7, FIG. 7 illustrates a series of blocks (or records) 710-740 in a blockchain 700. The blocks 710-740 are each entries in the blockchain 700 and are inserted sequentially in order of creation. Each block is distinct from the block before it (or it is the first block 710 in the blockchain 700), but is also linked to the prior block via a hashed pointer, thereby creating a sequential chain of blocks or “blockchain.” The hashed pointer in this example is a hash of the previous block, which in turn has a hashed pointer to the next previous block, and so forth. Because the hashed pointers are generated based on the previous block, any changes made to a previous block in the blockchain 700 can be detected if the hash is recomputed since it will differ from the hashed pointer in the next block. Thus, it can be exceedingly difficult to change values in blocks once they are stored on the blockchain 700. The blockchain 700 can therefore be used to securely store KarmaCredit transactions as they occur.

In this example, each block 710-740 in the blockchain 700 stores information about a transfer of KarmaCredits and each block stores the same types of information: (a) a transaction date or time (or both), (b) a transaction location, e.g., a shopping website, a company website, a brick and mortar store location, etc., (c) an owner ID representing the recipient of the KarmaCredits, (d) the prior owner ID representing the transferor of the KarmaCredits, (e) the associated product, (f) the associated company or brand, (g) the impact score for the company or brand, (h) the sale price for the product, (i) the number of KarmaCredits, (j) and the transaction type, e.g., initial issuance, exchange for goods, incentive reward, etc. When a new transaction occurs, a new block is added to the blockchain 700 at one location within the blockchain network and the change to the blockchain 700 is distributed to the other copies of the blockchain 700 in the blockchain network. Thus, each node maintains a complete record of the blockchain 700 and the transactions that have taken place, which provides further protection against tampering with the blockchain history at one node within the blockchain network. It should be appreciated, however, that the fields in the block discussed above are examples, and any suitable group of fields may be employed.

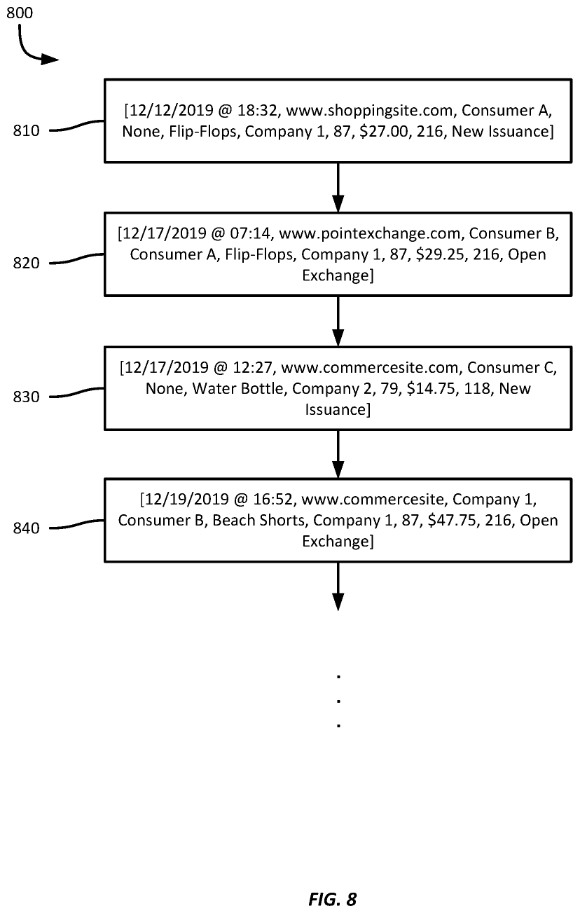

Referring now to FIG. 8, FIG. 8 illustrates a blockchain 800 generated based on KarmaCredit transactions. When a consumer purchases an item from a company via a shopping website 610a, the shopping website 610a creates a new block 810 for the blockchain 800 and supplies the data for each field in the block 810. The block is added to the blockchain 800 and the new block is distributed to the other nodes in the blockchain network. In this example, the first block 810 in the blockchain 800 indicates the issuance of new KarmaCredits for sale of a Company 1 product via the www.shoppingsite.com shopping website. The block 810 records the specific information for each field specified in FIG. 7.

Once the block 810 is recorded on the blockchain 800, a new transaction occurs where consumer A sells KarmaCredits to consumer B. In this case, the new block 820 stores the information relevant to the new transaction, but retains some of the information from the prior transaction, such as the company, the impact score, and the number of KarmaCredits. However, the sales price represents the amount consumer B paid to consumer A for the KarmaCredits. Again the new block 820 is added to the blockchain 800 along with a hashed pointer to the prior block 810. Additional blocks 830-840 may be added based on additional transactions occurring at various sites, with the relevant information stored in the new blocks 830-840, which are then distributed to the other nodes in the blockchain network. The blockchain 800 thus represents the series of transactions that have occurred. However, individual entities may have accounts or virtual wallets representing summary information based on these transactions, such as a number of KarmaCredits owned. Thus, entities can easily see how many KarmaCredits they have available, while the blockchain 800 stores a verifiable record of transactions to confirm the balance in the respective entity's account or wallet.

When creating KarmaCredits, one or more new transactions may be recorded in the blockchain. To create these KarmaCredits, the impact score service 630 may generate records that identifies the entity receiving the KarmaCredits, the transferor of the KarmaCredits, the quantity of KarmaCredits, and the date of the transfer. Different example systems may store different kinds of information in blockchain records. For example, a blockchain record may identify the item sold, the company that sold the item, the selling website, the sale price, the impact score for the company, the number of KarmaCredits, the type of exchange (e.g., issuance of new KarmaCredits, exchange of KarmaCredits, etc.), the consumer's name (or other identifier), etc. In some examples, a new issuance of KarmaCredits may be cryptographically signed by the issuer, e.g., by the impact score service 630, to show that the KarmaCredits are validly issued. The cryptographic signature may be based on information about the sale, such as the buyer, the seller, the sales price, the date of the transaction, etc., and generated using the issuer's private key, which may then be verified using the issuer's public key.

In some examples, however, KarmaCredits may be transferred from one entity to another. For example, a company 640a may run a promotion for various products during which consumers may exchange KarmaCredits for part (or all) of the sales price for those products. In such a case, a consumer may purchase a product for sale and exchange a number of KarmaCredits when purchasing the product, e.g., based on the then-current value of the KarmaCredits. The KarmaCredits may be transferred from the consumer to the company 640a-k selling the product, to the shopping website 620a-m, or the KarmaCredits may be divided between them or with other entities, as appropriate. Further, in some examples, an entity, such as a company 640a-k, may desire to obtain additional KarmaCredits and offer to purchase KarmaCredits from one or more other entities, such as consumers. Again such a transfer may indicate the parties, the exchange price for the KarmaCredits, the number of KarmaCredits, etc. Such transfers may occur on a dedicated KarmaCredit exchange 650, e.g., in exchange for goods or legal tender currency, or may occur via a shopping website 620a-m, e.g., an online marketplace or the company's own website.

By using these techniques, the impact score service may issue KarmaCredits to various entities and support the use of those KarmaCredits in the purchase of goods and services, their transfer on an open exchange, or redemption during a promotional event. Further, consumers are motivated to purchase companies from companies with higher impact scores because those companies will likely issue more KarmaCredits as they will be allocated more per dollar of sales revenue.

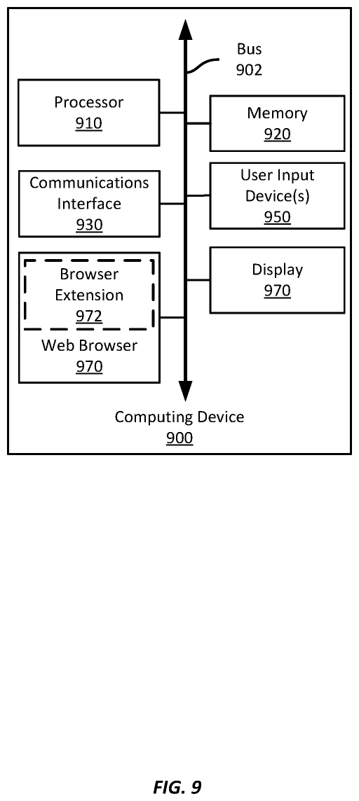

Referring now to FIG. 9, FIG. 9 shows an example computing device 900 suitable for use in example systems or methods for modifying web pages with ancillary content according to this disclosure. The example computing device 900 includes a processor 910 which is in communication with the memory 920 and other components of the computing device 900 using one or more communications buses 902. The processor 910 is configured to execute processor-executable instructions stored in the memory 920 to perform one or more methods for region-of-interest automatic exposure control according to different examples, such as part or all of the example method 200 described above with respect to FIG. 2. The computing device 900, in this example, also includes one or more user input devices 950, such as a keyboard, mouse, touchscreen, microphone, etc., to accept user input. The computing device 900 also includes a display 970 to provide visual output to a user.

The computing device further includes a web browser 970 and a browser extension 972, generally as described above with respect to FIG. 1. It should be appreciated that not all computing devices according to this disclosure include a web browser 970 and browser extension 972. For example a computing system hosting a shopping website 120a-m or an impact score service 130 may lack some components illustrated in FIG. 9, such as the web browser 970 and browser extension 972 or user input device 950 or display 970.

The computing device 900 also includes a communications interface 970. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
detecting an identifier for a requested shopping web page, the identifier comprising product information;
requesting impact score information based on the product information;
receiving the requested shopping web page;
receiving the impact score information;
modifying the shopping web page to add the impact score information; and
displaying the modified shopping web page.

2. The method of claim 1, wherein modifying the shopping web page comprises inserting a button into the shopping web page, and further comprising:
displaying the button.

3. The method of claim 2, further comprising:
detecting a press of the button; and
responsive to detecting the press of the button, displaying at least a portion of the impact score information.

4. The method of claim 3, wherein displaying at least a portion of the impact score information comprises displaying an overlay window over the shopping web page, the overlay window comprising the at least a portion of the impact score.

5. The method of claim 1, wherein displaying the modified shopping web page comprises displaying at least a portion of the impact score information.

6. The method of claim 5, wherein displaying at least a portion of the impact score information comprises displaying an overlay window over the shopping web page, the overlay window comprising the at least a portion of the impact score.

7. The method of claim 1 further comprising:
requesting additional product information for alternate products associated with the product information;
receiving the additional product information, the additional product information comprising information identifying one or more alternate shopping web pages and additional impact score information associated.

8. The method of claim 7, further comprising modifying the shopping web page to include the additional product information.

9. The method of claim 8, further comprising displaying the additional product information as a part of the shopping web page.

10. The method of claim 8, further comprising displaying the additional product information in an overlay window over the shopping web page.

11. The method of claim 1, further comprising:
scanning, using a scanning device, a product code on a product;
determining a product corresponding to the product code; and
transmitting a request for the shopping web page.

12. The method of claim 11, wherein the shopping web page corresponds to a store in which the product is being sold.

13. A system comprising:
a non-transitory computer-readable medium;
a communications interface; and
a processor communicatively coupled to the non-transitory computer-readable medium and the communications interface, the processor configured to execute processor-executable instructions configured to cause the processor to:
detect an identifier for a requested shopping web page, the identifier comprising product information;
request impact score information based on the product information;
receive the requested shopping web page;
receive the impact score information;
modify the shopping web page to add the impact score information; and
display the modified shopping web page.

14. The system of claim 13, wherein the processor is configured to execute further processor-executable instructions configured to cause the processor to:
insert a button into the shopping web page
display the button;
detect a press of the button; and
responsive to detection of the press of the button, display at least a portion of the impact score information.

15. The system of claim 14, wherein the processor is configured to execute further processor-executable instructions configured to cause the processor to display an overlay window over the shopping web page, the overlay window comprising the at least a portion of the impact score.

16. The system of claim 13, wherein the processor is configured to execute further processor-executable instructions configured to cause the processor to:
request additional product information for alternate products associated with the product information;
receive the additional product information, the additional product information comprising information identifying one or more alternate shopping web pages and additional impact score information associated.

17. The system of claim 16, wherein the processor is configured to execute further processor-executable instructions configured to cause the processor to modify the shopping web page to include the additional product information.

18. The system of claim 17, wherein the processor is configured to execute further processor-executable instructions configured to cause the processor to display the additional product information as a part of the shopping web page.

19. The system of claim 17, wherein the processor is configured to execute further processor-executable instructions configured to cause the processor to display the additional product information in an overlay window over the shopping web page.

20. The system of claim 13, wherein the processor is configured to execute further processor-executable instructions configured to cause the processor to:
scan, using a scanning device, a product code on a product;
determine a product corresponding to the product code; and
transmit a request for the shopping web page.
